(19) United States
(12) Patent Application Publication
(10) Pub. No.: US 2021/0049685 A1
(43) Pub. Date: Feb. 18, 2021

(54) SYSTEMS AND METHODS FOR MANAGING CRYPTOCURRENCY

(71) Applicant: Coinbase, Inc., San Francisco, CA (US)

(72) Inventors: William Tachau, San Francisco, CA (US); Nicholas DeMonner, San Francisco, CA (US); David Marcin, San Francisco, CA (US)

(21) Appl. No.: 16/987,180

(22) Filed: Aug. 6, 2020

Related U.S. Application Data
(60) Provisional application No. 62/885,463, filed on Aug. 12, 2019.
(60) Provisional application No. 62/944,285, filed on Dec. 5, 2019.
(60) Provisional application No. 62/971,506, filed on Feb. 7, 2020.

(51) Int. Cl. G06Q 40/02; G06Q 20/06; G06Q 40/06; G06Q 20/40

(52) U.S. Cl. CPC G06Q 40/025; G06Q 20/065; H04L 9/06; G06Q 20/4037; G06Q 40/06

(57) ABSTRACT

Systems and methods for managing cryptocurrency. Cryptocurrency can be managed for borrowing, margin trading, and/or use as collateral. Cryptocurrency data can be monitored and validated for identifying events and performing actions related to management of cryptocurrency.

### CROSS-REFERENCE TO RELATED APPLICATIONS

This application claims priority to US Provisional Application No. 62/885,463, filed 12 Aug. 2019, US Provisional Application No. 62/944,285, filed 5 Dec. 2019, and U.S. Provisional Application No. 62/971,506, filed 7 Feb. 2020, which are each incorporated herein in its entirety by this reference.

### TECHNICAL FIELD

This invention relates generally to the cryptocurrency field, and more specifically to a new and useful system and method for managing cryptocurrency.

### BACKGROUND

There is a need in the computer networking field to create new and useful systems and methods for using and managing cryptocurrency. This disclosure provides such new and useful systems and methods.

### BRIEF DESCRIPTION OF THE FIGURES

FIGS. 1A-D are schematic representations of a system, in accordance with variations.

FIGS. 2A-D, 4 and 7 are representations of a method, in accordance with variations.

FIG. 3 is an exemplary representation of margin states, in accordance with variations.

FIG. 5 is a schematic representation of a lending pool, in accordance with variations.

FIGS. 6A-D show exemplary data recorded for loans, in accordance with variations.

FIG. 6E shows exemplary interest calculation data, in accordance with variations.

### DESCRIPTION OF THE PREFERRED EMBODIMENTS

The following description of embodiments is not intended to limit the claims to these embodiments, but rather to enable any person skilled in the art to make and use embodiments described herein.

### 1. Overview.

There is a need in the cryptocurrency field for systems and methods for lending and borrowing cryptocurrency. For example, cryptocurrency can be borrowed to be sold in connection with a short sale. Similarly, fiat or stable coin can be borrowed to purchase cryptocurrency on margin. As another example, if a user needs a certain cryptocurrency to perform an operation (e.g., in connection with operation of a smart contract, etc.), but the user does not already own the cryptocurrency, the user can borrow the cryptocurrency at the time it is needed (which might be a low latency operation) rather than purchase the cryptocurrency on an exchange (which might be a high latency operation). However, the needs for borrowing cryptocurrency are not limited by these examples.

To limit a lender's risk in lending cryptocurrency, lenders often require the borrower to provide collateral, and periodically (or continuously) monitor repayment risk by tracking the value of the collateral and the value of the loan. The systems and methods disclosed herein enable a borrower to use assets in their cryptocurrency portfolio as collateral. In a case where cryptocurrency assets are used as collateral for a loan, the value of the collateral can decrease (sometimes dramatically) as the underlying price for the cryptocurrency asset decreases. Similarly, in a case where the borrower is borrowing a cryptocurrency asset, the value of the loan (relative to the collateral) can increase (sometimes dramatically) as the underlying price for the borrowed cryptocurrency asset increases. Therefore, it is advantageous to accurately determine prices for cryptocurrency assets used as collateral for a loan (or borrowed in connection with the loan), and protect against market and/or price manipulation of cryptocurrency assets.

Protections against market and/or price manipulation for other financial assets exist. However, many of these protections do not apply to cryptocurrencies because of the underlying differences between cryptocurrency assets and most other publicly traded assets.

For example, stocks are traded on highly regulated exchanges (e.g., NYSE, NASDAQ in the United States, etc.) with set trading hours (e.g., 9:30 pm EST to 4 pm EST, weekdays), and represent ownership in public companies. Issuers of stocks publicly traded in the United States are required to file a comprehensive annual report (10-K) about the company's financial performance with the U.S. Securities and Exchange Commission (SEC). Moreover, the identities of the largest shareholders of most publicly traded stocks are publicly available. Information about insider transactions (trades made by directors and officers of the company represented by the stock) is also publicly available. Furthermore, trades by insiders are regulated by insider trading laws, and breaking such laws can result in financial penalty or jail time. Therefore, there are safeguards in place to limit and discourage market and price manipulation of publicly traded U.S. stocks.

In contrast, cryptocurrencies are a relatively new type of asset, with relatively limited regulation and oversight. Cryptocurrencies can be traded over several exchanges, each operating in different countries (e.g., Coinbase in the United States, Binance in China, etc.). There are no set trading hours for cryptocurrencies, and trades can occur at any time of the day, any day of the week. Most cryptocurrencies are not backed by publicly traded companies, and there are no financial reporting requirements for most issuers of cryptocurrencies. Moreover, for many commonly traded cryptocurrencies, the identities of the largest holders of the cryptocurrency are unknown. Unlike U.S. stocks, there are minimal (if any) standardized safeguards against market and price manipulation for cryptocurrencies. As a result, in comparison with U.S. stocks, evaluating the credibility of a cryptocurrency price can be a non-trivial task.

The systems and methods disclosed herein enable borrowing (and lending) using cryptocurrencies. Cryptocurrency assets can be borrowed. Cryptocurrency assets can also be used as collateral for borrowed cryptocurrency assets, fiat, etc. To limit lending risk, loan monitoring is performed to periodically (or continuously) evaluate loan repayment risk by tracking the value of the collateral and the value of the loan. In determining value of a cryptocurrency asset, a robust market data ingestion process is performed to protect against market manipulation (e.g., by ingesting market data from a trusted source, performing price dislocation with other exchanges, performing anomaly detection to identify potentially invalid price information, etc.). Moreover, risk monitoring can be performed to identify lending risk for a given borrower, or across several borrowers, and alerts or actions can be automatically triggered based on the risk monitoring.

### 2. Benefits.

This method can confer several benefits over conventional systems and methods.

First, performing a robust market data ingestion process can protect against market and price manipulation.

Second, risk monitoring can be performed to identify lending risk for a given borrower (or across several borrowers). Alerts or actions can be automatically triggered based on the risk monitoring.

Third, by virtue of using a liquidation planner to determine whether to perform a liquidation for a portfolio, premature liquidation, or liquidations having adverse effects can be avoided. In some variations, intelligent liquidation is performed based on at least one of: a numeric overall profile equity percentage for a portfolio; a numeric equity percentage per cryptocurrency asset, for the portfolio; a numeric risk score value for the portfolio; a previous margin state for the portfolio; a current margin state for the portfolio; and recommended action for the portfolio.

Fourth, by virtue of using a liquidation planner to determine whether to perform liquidation, intelligent liquidation can be automatically performed to close a margin loan to comply with the Commodities Futures Trading Commission's rules (e.g., 28 day rule).

Fifth, by virtue of the system and method disclosed herein, assets liquidated for compliance with the 28 day rule can be automatically re-acquired by performing a margin transaction (thereby resulting in a new margin loan).

Sixth, variants of the system can reduce computational cost by persisting only the last-used and current price data values (e.g., used for each profile's borrowing power computation) in unlogged tables, where the values can be dynamically computable from other logged tables. These variants can optionally persist profile-specific borrowing power, withdrawal power, buying power, maximum loan size, and/or other user data in logged tables, which can be computed: upon request, when the value change in collateral and/or borrowed asset exceeds a threshold, when the computation cost falls below a predetermined threshold, and/or at any other suitable time. This can drastically decrease computational cost (and/or read/write queries) for updating the prices per profile by deferring price data recomputation in cases where the current price is relatively close to the last-used price (e.g., within a predetermined threshold of the last-used price) and/or deferring price data recomputation until borrowing power computations need to be made. This can be particularly advantageous when the assets are volatile (e.g., requiring high-frequency read/write cycles) and/or when each read/write call has a monetary cost. However, the computational cost can be otherwise managed.

### 3. System.

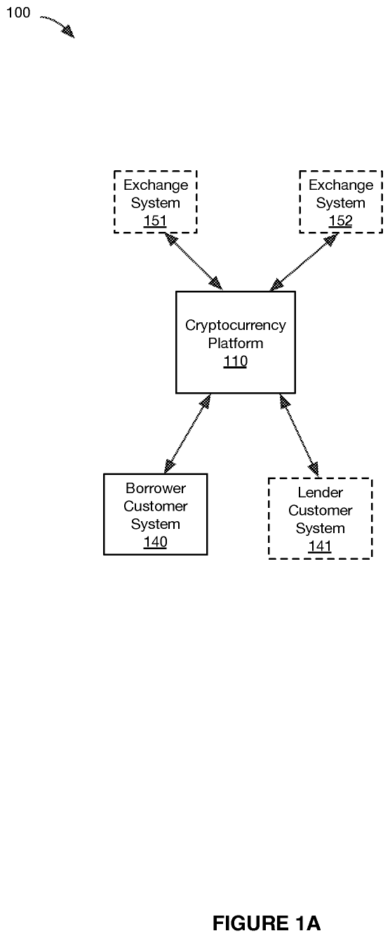

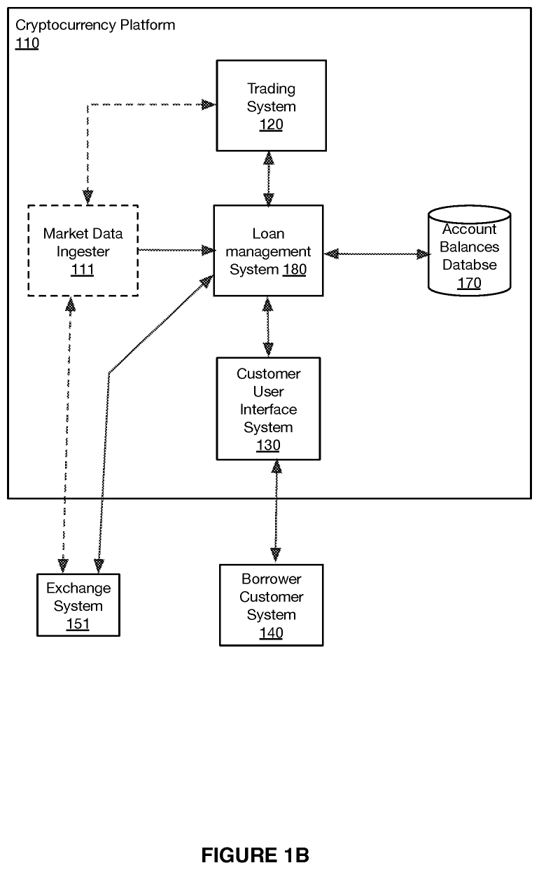

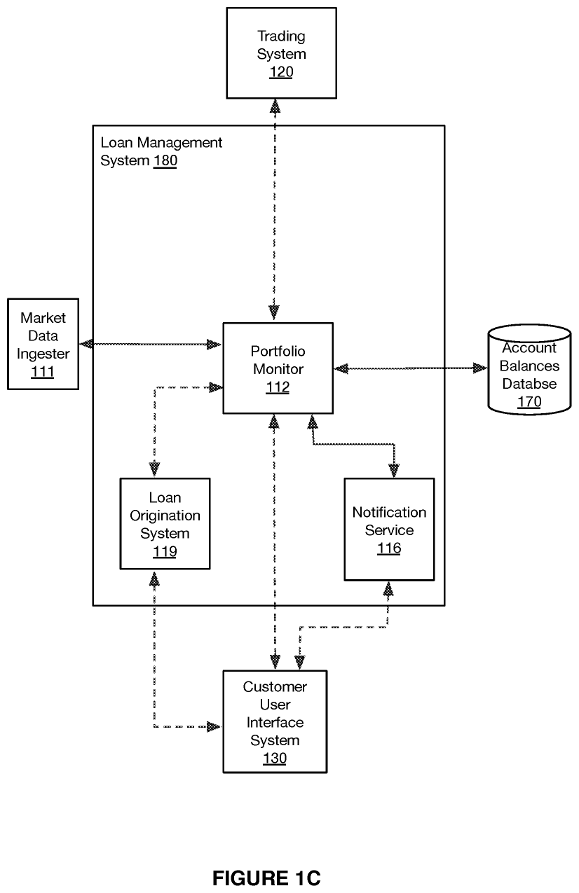

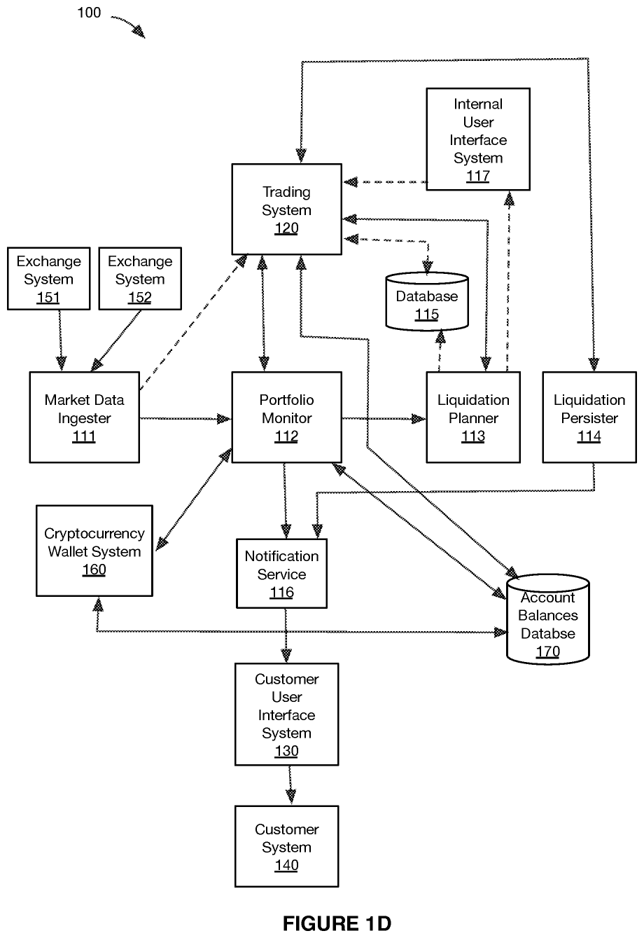

FIGS. 1A-D are schematic representations of a system, in accordance with variations. In some variations, the system 100 includes a cryptocurrency platform 110 (e.g., as shown in FIG. 1A). The platform 110 can be communicatively coupled to one or more exchange systems (e.g., 151, 152), and one or more customer systems (e.g., a borrower system 140, a lender system 141). The cryptocurrency platform 110 can function to provide various cryptocurrency functionality, such as, providing a cryptocurrency exchange, providing a multi-tenant hosted digital wallet, providing cryptocurrency loan management, providing custody of cryptocurrency assets, and other functionality and services related to cryptocurrencies.

In some variations, the cryptocurrency platform 110 includes one or more of a loan management system 180, a market data ingester 111, and an account balances database 170 (e.g., as shown in FIG. 1B). The cryptocurrency platform can optionally include a user interface system 130 that functions to provide a user interface to one or more customer systems (e.g., 140, 141) for interacting with the cryptocurrency platform 110.

In some variations, the loan management system 180 functions to monitor originated loans. The loan management system 180 can manage loans for several users of the cryptocurrency platform 110, and optionally manage several loans for at least one user. Loans can include loans of fiat or cryptocurrency assets. For example, a user of the platform 110 can receive a loan of Bitcoin (BTC) (e.g., to short sell BTC), and repay the loan using BTC. Alternatively, a user can receive a loan in fiat (or stablecoin, such as USDC) (e.g., to buy BTC), and repay the loan using fiat (or stablecoin). Cryptocurrency assets owned by the user (e.g., held in an account custodied at the platform 110) can be used as collateral for a loan. The loan management system can monitor repayment risk by tracking the value of the loan collateral and by tracking the value of the loan. For example, a user can borrow BTC and use Ethereum (ETH) as collateral for the BTC loan. In this example, the loan management system 180 tracks the value of the loan collateral (ETH) by tracking the price of ETH. Similarly, the loan management system 180 tracks the value of the loan by tracking the price of BTC.

In some variations, the loan management system 180 tracks prices of cryptocurrency assets by accessing market data from one or more market data sources (e.g. 120). The loan management system 180 can access the market data directly from one or more market data sources, or access the market data indirectly via a market data ingester 111.

In some variations, the loan management system 180 functions to protect against price and/or market manipulation. Additionally, or alternatively, a market data ingester (e.g., 111) can function to protect against such manipulation.

Price and market manipulation for cryptocurrency assets can arise due to the decentralized and unregulated (or semi-unregulated) nature of cryptocurrency trading. For example, a cryptocurrency asset (e.g., BTC) can be traded on several different cryptocurrency exchanges, operating in different countries and subject to different regulations and controls. Those same cryptocurrency assets can also be traded in a decentralized (e.g., peer-to-peer) manner using a decentralized exchange.

In some variations, to protect against price and market manipulation, the loan management system 180 accesses market data from a trusted source (e.g., a cryptocurrency exchange, a market data provider, etc.). The trusted source can be a system managed by the platform 110 (e.g., the trading system 120), or an external system (e.g., exchange 151, 152). In some variations, the loan management system 180 accesses market data from several trusted sources and compares the market data from each source to identify price dislocation or potentially anomalous or fraudulent price values. In some implementations, loan management system 180 accesses market data from the trading system 120.

The trading system 120 functions to provide a cryptocurrency exchange to buy cryptocurrency assets (using fiat, or another cryptocurrency asset), or sell cryptocurrency assets (for fiat, or another cryptocurrency asset). In variants, the trading system 120 performs one or more of: providing price quotes for one or more cryptocurrency assets (e.g., prices in fiat or in other cryptocurrencies), performing electronic trade execution, performing trade and/or volume reporting, and performing automated trading. In variants, the trading system additionally performs at least a portion of loan origination (e.g., as described herein).

In an example, the trading system 120 is included in the platform 110, and operated by the same entity that operates the loan management system 180. In some variations, the trading system 120 functions to protect against price and market manipulation. In a first example, the trading system 120 performs KYC (Know Your Customer) checks for all users of the trading system 120. In a second example, the trading system 120 functions to detect (and optionally block) transactions (or sets of transactions) that pose a price or market manipulation risk. For example, if a user orders a set of large trades, or if traders appear to be colluding to manipulate the price of a cryptocurrency asset, the trading system 120 can block such trades. By integrating such protections against price and market manipulations within the trading system 120, price data provided by the trading system (e.g., price data generated from trades placed using the trading system 120) can be trusted by the loan management system 180. In implementations in which the loan management system 180 and the trading system 120 are operated by the same entity, further price and market data protections useful for loan management can be integrated into the trading system 120.

In some variations, the accessed price data (e.g., provided by the trading system 120, an exchange 151, 152) includes additional information that can be used by the loan management system 180 (or the market data ingester 111) to validate the price data and optionally label (or remove) potentially invalid (or fraudulent) price data.

In some variations, the loan management system 180 functions to originate a loan (e.g., by using a loan origination system 119 shown in FIG. 1C). Additionally, or alternatively, the trading system 120 can originate a loan (e.g., in connection with a margin trade or a short sell), and inform the loan management system 180 of loans originated by the trading system 120.

In some variations, the loan management system 180 includes one or more of a loan origination system 119, a portfolio monitor 112, and a notification system 116 (as shown in FIG. 1C).

In some variations, the system 100 optionally includes at least one of: a liquidation planner 113, a liquidation persister 114, a database 115, and an internal user interface system 117 (as shown in FIG. 1D).

In some variations, the trading system 120 functions to originate a loan in connection with a margin transaction. In some variations, the trading system 120 functions to determine a collateral amount for a trading transaction request, use the collateral amount to determine borrowing power, and process the margin transaction if there is sufficient borrowing power. In some variations, the trading system 120 functions to determine a borrowing power amount for a portfolio based on account balances recorded by an account balances database (e.g., 170) and market data information provided one of the portfolio monitor 112 and the market data ingester 111. In some variations, the trading system 120 functions to receive information identifying a borrowing power amount for a portfolio from the portfolio monitor 112.

In some variations, the system 100 includes a wallet system 160 that functions to originate a loan. In variants, the originated loan can be related to a margin transaction. In some variations, the wallet system 160 functions to determine a collateral amount for a transaction request, use the collateral amount to determine borrowing power, and process the margin transaction if there is sufficient borrowing power. In some variations, the wallet system 160 functions to determine a borrowing power amount for a portfolio based on account balances recorded by an account balances database (e.g., 170 and market data information provided one of the portfolio monitor 112 and the market data ingester 111. In some variations, the wallet system 160 functions to receive information identifying a borrowing power amount for a portfolio from the portfolio monitor 112.

In some variations, an account balance database 170 records account balances for each portfolio managed by the trading system. The account balance database can be a database of the wallet system, a database of the trading system, a centralized database accessible by both the wallet system and the trading system, or any suitable database.

In some variations, the market data ingester 111 functions to aggregate market data from one or more sources (e.g., a plurality of cryptocurrency exchanges, such as 151, 152). The market data ingester 111 can standardize ingested data into a standard format and distribute the standardized, aggregated data in a data stream. In some variations, the data provided by the market data ingester 111 (e.g., via a. data message) is provided via an event bus (e.g., a Kinesis event bus). Any suitable type of event bus can be used to distribute data from the market data ingester 111 to other components of the system 100.

In some variations, the portfolio monitor 112 functions to identify a loan event. In some variations, the portfolio monitor 112 uses data messages provided by the market data ingester 111 to identify loan events.

In some variations, the portfolio monitor 112 functions to monitor positions of individual users' loan profiles with current market data (e.g., provided by the market data ingester 111), and provide loan event notifications to other components of the system 100 (e.g., via an event bus) based on defined rules and thresholds that describe the health of individual portfolios. In some implementations, the portfolio monitor 112 functions to track the “loan health history” of portfolios over time to aid in risk assessment. In some implementations, the portfolio monitor 112 functions to publish a notification event when a user balance is below a threshold, and calculate a risk score based on current and past portfolio balances and market metrics.

In some variations, the system 100 includes a liquidation planner 113 that functions to process a loan event (e.g., identified in a notification received from the portfolio monitor 112). In some variations, the liquidation planner 113 functions to process a loan event by instructing the trading system 120 to perform a liquidation transaction. In some implementations, the liquidation planner 113 instructs the trading system 120 to perform a liquidation transaction directly. In some implementations, the liquidation planner 113 instructs the trading system 120 to perform a liquidation transaction by providing liquidation information to the user interface system 117, which confirms the liquidation (e.g., based on received user input), and the user interface system 117 instructs the trading system 120 to perform the liquidation transaction. In some implementations, the liquidation planner 113 instructs the trading system 120 to perform a liquidation transaction by storing liquidation information in the database 115, the trading system 120 receives the liquidation information from the database 115, and the trading system performs the liquidation based on the information retrieved from the database 115.

In some variations, the system 100 includes a liquidation perister 114 that functions to provide a liquidation message that includes information for a liquidation performed by the liquidation planner 113.

In some variations, the customer user interface system 130 functions to provide notification information received via the notification service 116 to at least one customer system 140. For example, the user interface system 130 can provide a user interface that notifies a user of a loan event detected by the portfolio monitor 112 or a liquidation performed by the liquidation planner 113 (e.g., via information provided by the liquidation persister 114).

In some variations, one or more of the components of the system are implemented as a hardware device that includes one or more of a processor (e.g., a CPU (central processing unit), GPU (graphics processing unit), NPU (neural processing unit), etc.), a display device, a memory, a storage device, an audible output device, an input device, an output device, and a communication interface. In some variations, one or more components included in a hardware device are communicatively coupled via a bus. In some variations, one or more components included in the hardware device are communicatively coupled to an external system via the communication interface.

The communication interface functions to communicate data between the hardware device and another device via a network (e.g., a private network, a public network, the Internet, and the like).

In some variations, the storage device includes the machine-executable instructions for performing at least a portion of the method 200 described herein.

In some variations, at least one component of the system 100 performs at least a portion of the method 200 described herein.

### 4. Method.

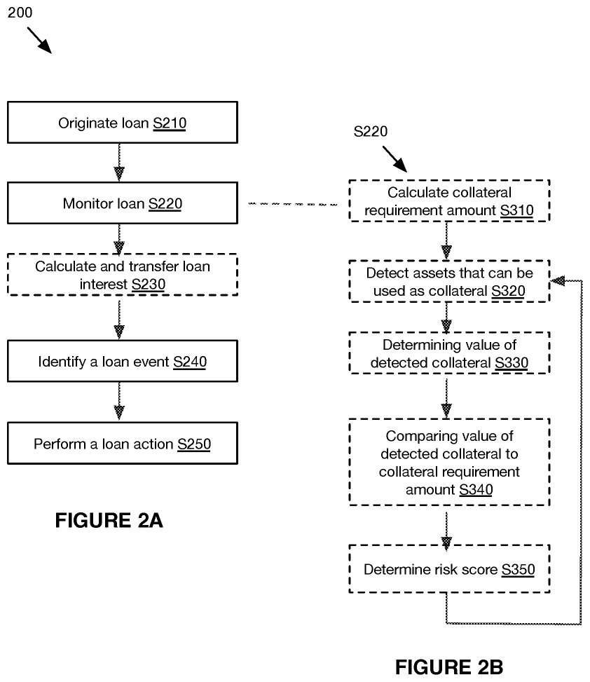

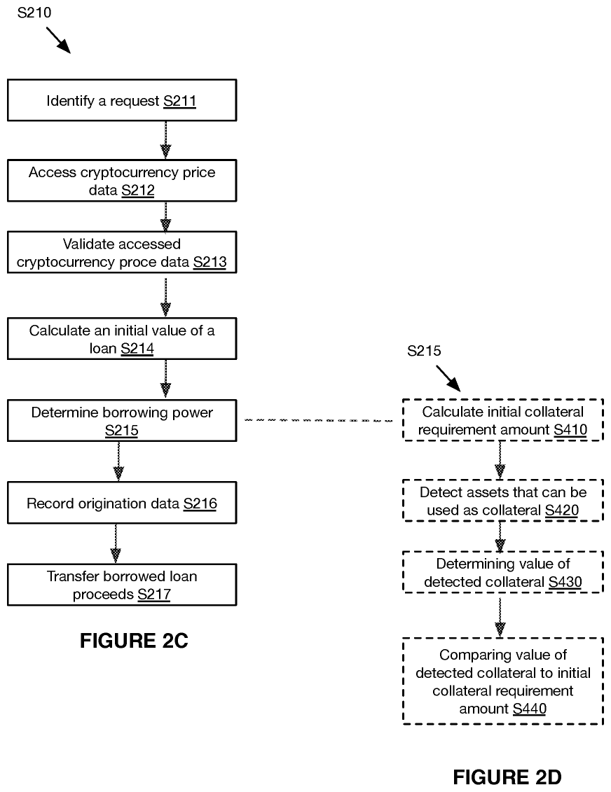

FIG. 2A is a flowchart representation of a method 200.

In variations, the method can include one or more of: originating a loan S210; monitoring the loan S220; identifying a loan event S240; and performing a loan action S250. The method 200 can optionally include calculating and transferring loan interest S230.

In some variations, at least one component of the system 100 performs at least a portion of the method 200.

The method can be performed for several users (e.g., of the cryptocurrency platform 110). The method can optionally be performed for several loans for the same user.

Originating a loan S210 can include one or more of: identifying a loan request S211 (loan of crypto, loan of fiat), accessing cryptocurrency price data S212; validating accessed cryptocurrency price data S213, calculating an initial value of the loan S214, determining borrowing power S215, recording loan origination data for the loan S216, and transferring borrowed loan proceeds (e.g., to a loan account) S217, as shown in FIGS. 2C and 7.

In a first variation, a loan management system 180 originates the loan. In some implementations, the loan management system 180 originates the loan in response to the loan request (e.g., identified at S211). In some implementations, the loan management system 180 receives the loan request via a user interface system (e.g., 130) from a user device operated by a borrower (e.g., 140) or a user device operated by an account representative acting on behalf of a borrower (e.g., at S211).

In a second variation, a trading system 120 originates the loan. In some implementations, the trading system 120 originates the loan in response to the loan request. In some implementations, the loan request is a margin request to execute a margin transaction. In some implementations, trading system 120 receives the margin request (e.g., at S211) via a user interface system (e.g., 130) from a user device operated by a borrower (e.g., 140) or a user device operated by an account representative acting on behalf of a borrower. In some implementations, the margin transaction is a trade (e.g., executed by the trading system 120) that exceeds an existing balance.

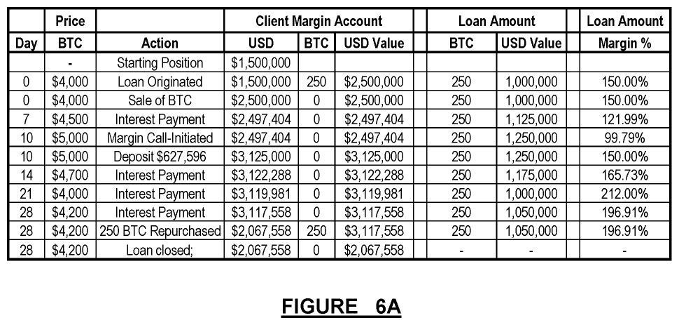

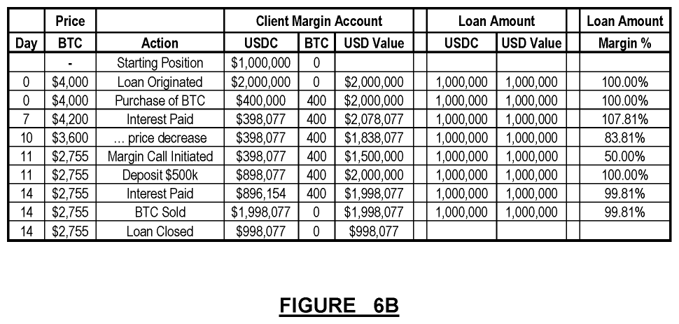

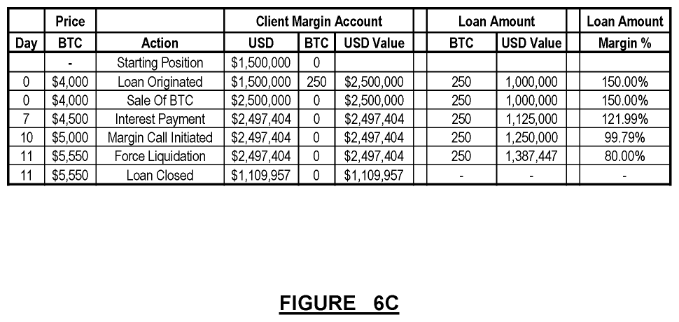

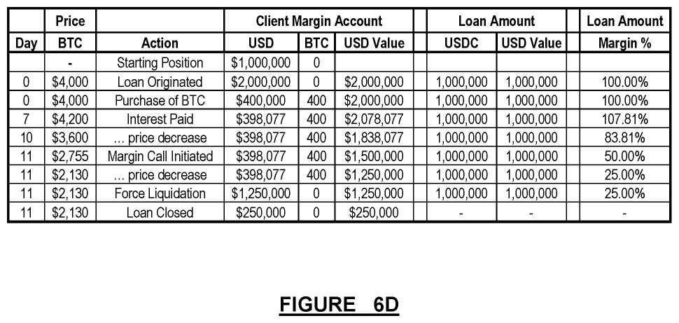

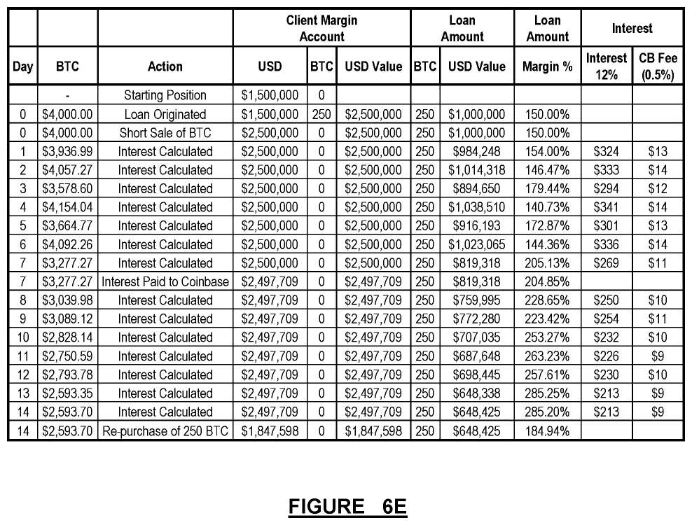

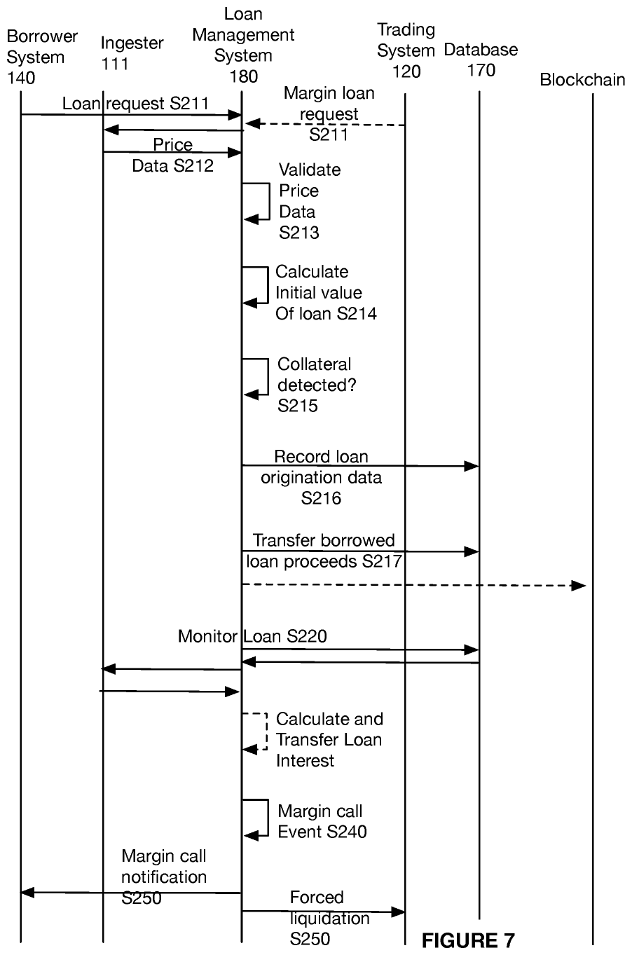

In a first example, in some implementations, a request to purchase Bitcoin (BTC) using an amount of USD (U.S. fiat currency) that exceeds a trading portfolio's USD balance is a margin transaction. A margin loan of USD (or USDC) (e.g., recorded at S216) is originated for the margin transaction to perform the purchase of the BTC (which can be used as collateral for the loan). FIG. 6B shows exemplary loan data recorded for a margin loan of $1,000,000 USDC to purchase 400 BTC at a price of $4,000 per BTC. As shown in FIG. 6B, the loan origination data is represented as the row having the Action column description “Loan Originated”. During execution of the margin transaction, the USD loan proceeds are transferred to an account (e.g., a client margin account) of the user executing the margin transaction (or recorded as being usable by the user in connection with the margin transaction) (e.g., at S217).

In a second example, in some implementations, a purchase of ETH using an amount of BTC that exceeds a portfolio's BTC balance is a margin transaction. A margin loan of BTC (e.g., recorded at S216) is originated for the margin transaction to perform the purchase of the ETH.

In some variations, the loan request (e.g., identified at S211) is one or a trade request, a withdrawal request, and a transfer request. In some implementations, the trading system 120 receives the loan request (e.g., request to execute a trade using a cryptocurrency exchange) at S211. In some implementations, the wallet system 160 receives the loan request (e.g., request to withdraw fiat currency or assets, or transfer fiat currency or assets) at S211.

In variants, the loan request (identified at S211) identifies one or more of: loan terms and liquidation metrics. Loan terms can identify one or more of: asset to be borrowed, expiration of loan, interest rate, amount to be borrowed, requested interest rate, amortization schedule, prepayment penalties, fixed rate period, collateral, or any other suitable loan term. Assets to be borrowed can include one or more of a cryptocurrency asset, a fiat currency asset, a real estate asset, or any suitable property or financial asset. Liquidation metrics can include an identifier of one or more market data (price data) sources used to access price data. Price data accessed from sources identified by liquidation metrics can be used for monitoring the loan, identifying loan events, and performing loan actions. In this manner, a borrower can have control over the data used to trigger margin calls and forced liquidation, and require use of a market data source that is trusted by the borrower.

Accessing cryptocurrency price data S212 can include accessing the cryptocurrency price data from one or more market data sources. Market data sources can include one or more of a cryptocurrency trading system, market data aggregator, block explorer, or any suitable type of system that functions to provide market data (including price data) for at least one cryptocurrency asset. In variants, the market data sources used to access the price data are identified by loan request (identified at S211). Additionally, or alternatively, account configuration data for the borrower identifies market data sources approved by the borrower. However, market data sources can otherwise be selected.

In some implementations, market data ingester 111 is used to access the cryptocurrency price data. The market data ingester 111 aggregates market data from data sources (e.g., a plurality of cryptocurrency exchanges, such as 151, 152). The market data ingester 111 can standardize ingested data into a standard format and distribute the standardized, aggregated data in a data stream. In an example, the data provided by the market data ingester 111 is provided via an event bus (e.g., a Kinesis event bus). Any suitable type of event bus can be used to distribute data from the market data ingester 111 to other components of the system 100.

In some variations, the cryptocurrency price data is included in a data message provided by one or more market data sources. In some implementations, data accessed from a market data source (e.g., via a data. message) identifies least one of: a source of the data (e.g., the cryptocurrency exchange providing the data); an asset identifier (e.g., “BTC”); a purchasing currency that identifies an asset or currency used to purchase the asset (e.g., “USD”); order book depth information for the order book for the asset identifier and the purchasing currency (e.g., a “BTC-USD” order book); and/or price information. In some implementations, order book depth information identifies at least one of: a total order book depth (e.g., calculated by the sum of each bid and ask multiplied by their respective price, etc.); the sum of each bid multiplied by its price; and/or the sum of each ask multiplied by its price. In some implementations, price information identifies at least one of: the highest bid on the order book; the lowest ask on the book; the price in between the highest bid and the lowest bid; the price of the last executed order; the absolute difference between the highest bid and the lowest ask; and/or the relative difference between the highest bid and the lowest ask. In some implementations, the relative difference between the highest bid and the lowest ask is calculated as follows: (1−highest_bid/lowest_ask). In an example, the highest bid of $98 and a lowest ask of $100 would have a 2% spread percentage. In some variations, each data message might identify (for the associated order book) how recent the orders on the order book are.

Validating the accessed cryptocurrency price data S213 can include: one or more of: verifying that a market data source as is trusted source, detecting for price dislocation with other exchanges, performing anomaly detection to identify potentially invalid price information, or any other suitable validation process. Verifying that a market data source as is trusted source can include identifying processes performed by the market data source to protect against price and market manipulation (e.g., anomaly detection, identification of fraudulent transactions, identifying market collusion, etc.).

Detecting price dislocation can include detecting price dislocation among cryptocurrency exchanges by using data accessed at S212 from a plurality of exchanges. Price dislocation can be determined based on: the mean, median, actual value, or other market metric of the other cryptocurrency exchanges' asset price. Price dislocation can be determined when the primary exchange's asset price deviates from the market metric by more than a threshold amount (e.g., percentage, common asset value, time duration, etc.), or otherwise determined.

Performing anomaly detection can include accessing additional data from one or more data sources (e.g., additional data included in a data message that also includes the price data), and using the additional data to perform anomaly detection. In some variations, price data is flagged as potentially anomalous if price dislocation is detected for a corresponding time period. Performing anomaly detection can include one or more of (for at least one asset and at least one time): assigning a confidence level to the price data, labeling the price data as potentially invalid or fraudulent, discarding the price data, or performing any suitable anomaly detection action.

Calculating an initial value of the loan S214 can include calculating the initial value of the loan based on the loan request identified at S211. In variants, an asset to be borrowed and a borrow amount identified by the loan request is identified. A fiat currency associated with the loan (e.g., associated with the borrower) is also identified. Alternatively, another cryptocurrency can be used as the base asset (e.g., for value calculation), such as a marginable asset (e.g., BTC, ETH, USDC, etc.), or other cryptocurrencies. Price data for the borrowed asset for a time associated with loan origination is identified from the price data validated at S213. In some variations, the loan amount is calculated by multiplying the price data for the borrowed asset by the borrowed amount. In some implementations, fees are added to the loan amount.

Determining borrowing power S215 can be performed by the system receiving the loan request (e.g., 120, 160, 180). However, any suitable component of the cryptocurrency platform 110 can determine the borrowing power. The borrowing power can be determined: at a predetermined frequency (e.g., on a predetermined schedule), in response to receipt of the loan request, continuously, in response to an asset price change, or at any other suitable time.

In some variations, borrowing power determined at S215 is used to determine whether to complete loan origination and fund the requested loan or complete a margin transaction.

Borrowing power for a user can be determined for a trading account of a user, a margin account of a user, a digital wallet of the user, or any suitable account or digital wallet whose balances are recorded for the user by the cryptocurrency platform 110 (e.g., in the account balances database 170). In some implementations, a trading account, margin account, or digital wallet groups a set of currencies (cryptocurrencies, fiat currencies), and the platform 110 records individual balances (account balances) for each currency included in a set of currencies.

In some variations, borrowing power is determined based on at least one of account balances for the user (e.g., trading account, margin account, digital wallet) and market price data information (e.g., accessed at S212). In some implementations, the account balances are recorded by an account balances database (e.g., 170).

For example, the platform 110 can record a USD balance, a BTC balance, and an ETH balance for a user's margin account, and the borrowing power for the user's margin account is determined based on the USD balance, the BTC balance multiplied by a BTC price in USD (e.g., accessed as described herein for S212 and S213), and the ETH balance multiplied by a ETH price in USD (e.g., accessed as described herein for S212 and S213). However, in some implementations, not all cryptocurrency assets are used to determine borrowing power. For example, balances of risky or volatile cryptocurrency assets can be excluded from borrowing power calculations.

In a first variation, determining borrowing power S215 includes determining whether a portfolio includes sufficient collateral to close a requested loan. Determining whether the portfolio includes sufficient collateral includes determining an initial collateral requirement amount (e.g., in fiat currency) for the loan (e.g., at S410 shown in FIG. 2D). In some implementations, calculating the initial collateral requirement amount includes identifying an initial collateral requirement (IC) (e.g., for the portfolio, for all portfolios of the user, for all users, etc.), and computing a product of the initial collateral requirement and the initial loan value (e.g., identified at S214). In an example, the initial collateral requirement is represented as a percentage. In some implementations, collateral value (determined at S420) for the collateral detected for the portfolio (at S420) is compared (at S440) to the initial collateral requirement amount (calculated at S410), and if the collateral value is at least equal to the initial collateral requirement amount, then the portfolio includes sufficient collateral to close the requested loan.

In a second variation, determining borrowing power includes determining an amount (borrowing power amount) that can be borrowed for a portfolio, given the portfolio's positions. In some implementations, calculating the amount (e.g., in fiat currency) that can be borrowed for the portfolio includes identifying the initial collateral requirement (IC), and dividing the collateral value (e.g., in the fiat currency) (for the collateral detected for the portfolio) by the initial collateral requirement, wherein the resulting quotient is the maximum amount that can be borrowed (borrowing power amount).

In a first example, determining the borrowing power amount includes: converting the value of the portfolio's assets and liabilities in common currency (e.g., USD); and computing the portfolio's borrowing power as the sum of the maximum allowed borrow amount (e.g., SUM(positions)*((1/initial collateral %)−1)) and the already borrowed amount (e.g., SUM(positions <0), wherein the already borrowed amount is a negative number. In some implementations, the portfolio's borrowing amount can be represented as the value of SUM(positions)/initial collateral %−SUM(positions >0), which can be converted into a value in units of any selected currency by applying an inverse common currency conversion.

In a second example, determining the borrowing power amount includes: converting the value of the portfolio's assets in a common currency (e.g., USD) (A); converting the value of the portfolio's liabilities in the common currency (e.g., USD) (L); identifying the initial collateral requirement (IC); and calculating the borrowing power amount as follows: Borrowing Power=[A(1−IC)−L]/IC. However, the borrowing power amount can be otherwise determined.

In some implementations, calculating the borrowing power amount includes considering the effect that holds will have on borrowing power. In an example, the value of non-marginable holds on assets (H_{NMA}) is determined, the value of non-marginable holds on liabilities (H_{NML}) is determined, and the value of marginable holds on liabilities (H_{ML}) is determined; and the borrowing power amount is calculated as follows: Borrowing Power=[A′(1−IM)−L′]/IM, wherein A′=A−H_{NMA}+H_{ML}, and L′=L−H_{NML}+H_{ML}. In some variations, a marginable hold is a hold on marginable assets (assets that can be used as collateral) for which the hold itself is considered collateral. In some variations, a non-marginable hold is a hold in which a marginable asset is used to buy a non-marginable asset, or is withdrawn from the platform. A borrowable currency is a currency (or asset) that can be borrowed for margin trading. In some implementations, spending a marginable asset to buy a borrowable currency that is a liability decreases assets and liabilities by the same amount (and is a “marginable” hold); spending a borrowable currency that is a liability to buy marginable assets increases assets and liabilities by the same amount (and is a “marginable” hold); spending a marginable asset to buy a non-marginable asset decreases assets (and is a “non-marginable” hold); spending a borrowable currency that is a liability to buy a non-marginable asset increases liabilities (and is a “non-marginable” hold). The borrowable currency or marginable asset can be “spent” by: decrementing the amount of spent asset associated with a portfolio or profile and increasing the amount of purchased asset associated with the portfolio or profile (e.g., in an off-chain ledger); generating and submitting an exchange order trading the spent asset for the purchased asset; or otherwise selling or purchasing an asset.

In variants, previously determined borrowing power amounts can be stored and used later to compute updated borrowing power amounts. In some implementations, determining the borrowing power amount includes accessing a stored borrowing power amount, locking the accounts of the portfolio assets whose price has changed since the determination of the stored borrowing power amount, and determining a new borrowing power amount based on the price changes of the locked accounts.

In some implementations, determining the borrowing power amount includes accessing a stored borrowing power amount, locking the accounts of the portfolio assets related to the loan request of S211, and determining a new borrowing power amount based on a transaction to be performed for the loan request.

In some implementations, the method 200 includes storing the last borrowing power amount determined for the portfolio and the prices of the portfolio assets used to determine the last borrowing power amount. In some implementations, S215 includes determining whether any portfolio asset prices have changed since calculation of the last borrowing power amount for the portfolio; if at least one price has changed above a threshold amount, the borrowing power amount is recomputed, otherwise, the last borrowing power amount is used as the current borrowing power amount for the portfolio.

In some implementations, S215 includes storing the determined borrowing power amount, the input values (e.g., asset prices, asset balances, etc.) used to determine the borrowing amount in a borrowing power data structure. In some variations, S215 includes determining whether to recompute a new borrowing power amount based on the data identified in the borrowing power data structure, and in a case where it is determined that a new borrowing power amount does not need to be calculated, the borrowing power amount identified in the borrowing power data structure is used as the new borrowing power amount.

In some variations, S215 includes determining a maximum withdrawal amount (e.g., in a case where the margin transaction is a withdrawal (or transfer) that exceeds an existing balance (A_{C}) for the currency being withdrawn (or transferred)). As a first example, in some implementations, a USD withdrawal that exceeds a portfolio's USD balance is a margin transaction. This margin transaction results in a loan of USD to fund the USD withdrawal. As a second example, in some implementations, a BTC withdrawal (or transfer) that exceeds a portfolio's BTC balance is a loan transaction. This loan transaction results in a loan of BTC to fund the BTC withdrawal. In some variations, the withdrawal (or transfer) amount cannot exceed a maximum withdrawal amount. In some variations, a first maximum withdrawal amount is calculated using Equation 1: Maximum Withdrawal Amount (W₁)=(1−IC)A−L+(IC*A_{C}); and a second maximum withdrawal amount is calculated using Equation 2: Maximum Withdrawal Amount (W₂)=A−[L/(1−IC)]. If W₁ is greater than A, then, W₁ is used as the maximum withdrawal amount. If W₂ is less than A, then, W₂ is used as the maximum withdrawal amount.

In some variations, calculating the maximum withdrawal amount includes considering the effect that holds will have on maximum withdrawal amount, and a first maximum withdrawal amount is calculated using Equation 3: Maximum Withdrawal Amount (W₃)=(1−IM)A′−L′+IM·AC′; and a second maximum withdrawal amount is calculated using Equation 4: Maximum Withdrawal Amount

$$( {W}_{4} ) = {A}^{′} - \frac{{L}^{′}}{1 - IM} ,$$

wherein A′=A−H_{NMA}+H_{ML}, L′=L+H_{NML}+H_{ML}; A_{C}′=max (0, A_{C}−H_{C}); and H_{C} represents an amount of holds for currency c. If W₃ is greater than A′, then, W₃ is used as the maximum withdrawal amount. If W₄ is less than A′, then, W₄ is used as the maximum withdrawal amount

In some variations, determining borrowing power S215 includes one or more of: calculating an initial collateral requirement amount for the loan S410, detecting assets that can be used as collateral for the loan S420; determining a value of assets that can be used as collateral S430; and comparing the value of the assets that can be used as collateral to the initial collateral requirement (as shown in FIG. 2D).

In variants, an initial collateral requirement amount for the loan is calculated based on a portfolio's maximum borrowed amount at S410. In some variations, the portfolio's initial collateral requirement (IC) (calculated at S410) is the minimum equity percentage allowed for borrowing (e.g., in connection with margin trading, short selling, etc.). While a portfolio's equity percentage may fall below this number due to price movement, a portfolio is not allowed to take actions that bring the portfolio's equity percentage below the portfolio's initial collateral requirement. The initial collateral requirement can be: a predetermined value (e.g., global value for all portfolios; set value for portfolios of the same class; etc.); a value determined based on the user or profile's: history, risk (e.g., financial risk), net worth, or other parameter; or otherwise determined. The portfolio's equity percentage is a portion of the portfolio's total portfolio value that is owned. For example, a portfolio with $100 of assets and $80 of liabilities, the equity percentage is 20%.

In variants, the value of assets (detected at S420) that can be used as collateral is preferably determined at S430 based on the market value (e.g., market price) in fiat currency, but can additionally or alternatively be determined based on the market value of cryptocurrency (e.g., all cryptocurrency assets, a subset of cryptocurrency assets, etc.), and/or any other suitable asset. In some variations, some cryptocurrency assets can be used as collateral for a loan, whereas other cryptocurrency assets cannot be used as collateral.

In some variations, detecting assets that can be used as collateral for the loan S420 includes identifying a set of cryptocurrency assets (collateral cryptocurrency assets) that can be used as collateral for a loan originated (or managed) by the cryptocurrency platform 110. In variants, a cryptocurrency asset is selected as a collateral cryptocurrency asset based on one or more attributes of the cryptocurrency asset. In some implementations, attributes used to select a cryptocurrency asset as a collateral cryptocurrency asset include one or more of liquidity, trading history, price history, blockchain block depth, order book depth, volatility (e.g., less than a threshold standard deviation of daily returns, such as 1%, 5%, 10%, 15%, etc.), cryptocurrency class (e.g., stablecoin or not), risk (e.g., manually or automatically determined), and/or any other suitable attribute. In some implementations, such attributes are identified by accessing validated cryptocurrency price data for the cryptocurrency asset (e.g., as described herein for S212 and S213). Additionally, or alternatively, such attributes include results of performing lending risk monitoring (e.g., at S220). Alternatively, collateral cryptocurrency can be manually selected or otherwise determined.

In some variations, the collateral value of collateral cryptocurrency assets can be weighted between 0%-100%, according to market risk (e.g., price volatility, order book depth, liquidity, etc.), or any suitable risk factor. In an illustrative example, Ethereum and Bitcoin can be used as collateral, and valued at 70% and 50% of the market value, respectively, while Litecoin is not usable as collateral (e.g., valued at 0% of the market value for collateral determination). In some variations, different assets (e.g., fiat, cryptocurrency assets) can be ranked, where higher-ranked assets are preferentially used as collateral for the loan, or otherwise used. The collateral cryptocurrency assets are preferably cryptocurrency assets that are not associated with an existing loan for the profile (e.g., a loan was not used to purchase those cryptocurrency assets, the cryptocurrency assets were not used as collateral for an existing loan, etc.), but can additionally or alternatively be cryptocurrency assets that are associated with an existing loan. In some variations, cryptocurrency assets or fiat currency held for open orders can be used as collateral. In some implementations, the collateral value of an asset (or fiat currency) held for an open order is determined based on the asset (or currency) to be acquired after fulfillment of the order. For example, if an asset that can be used as collateral is held for an open order that results in an exchange of the asset for a new asset that cannot be used as collateral, then the amount of the asset that is on hold is not counted as collateral when determining the collateral value of the portfolio. In some implementations, the collateral value of an asset (or fiat currency) held for an open order is determined based on the asset (or currency) to be acquired after fulfillment of the order, and a probability of the order being fulfilled. For example, if an asset that can be used as collateral is held for an open order that results in an exchange of the asset for a new asset that cannot be used as collateral, then the collateral value of the asset can be weighted based on likelihood of the order being fulfilled. For example, an order to purchase an asset at price well below historical bid prices might have a low probability of being fulfilled.

In some variations, at S440, the determined value of detected collateral for a portfolio (e.g., a portfolio of a trading account, margin account, wallet, etc.) is compared with the initial collateral requirement calculated at S410.

In some variations, originating the loan S210 can include processing a transaction that triggers loan origination. Transactions that can trigger a loan origination include one or more of: a margin transaction, withdrawal from a hosted wallet, a transfer from a hosted wallet to another cryptocurrency wallet, or any other type of transaction that requires an amount of funds greater than the amount of funds owned by the user associated with the portfolio. A margin transaction can be a trade facilitated using a cryptocurrency exchange (e.g., the trading system 120). A withdrawal or transfer transaction can be processed by the wallet system 160.

In some variations, processing a transaction that triggers loan origination includes: comparing the portfolio's borrowing power (or maximum withdrawal amount) (determined at S215) with a threshold amount, and processing the transaction responsive to a determination that the portfolio's borrowing power (or maximum withdrawal amount) exceeds the threshold amount. In some implementations, the threshold amount is a combined value of assets held for the portfolio for open orders (e.g., orders to be fulfilled by the trading system 120) and assets to be held for the transaction to be processed.

In some variations, processing a transaction that triggers loan origination includes: determining whether the portfolio has borrowing power that is greater than the sum of: 1) the value of existing holds (e.g., value of assets held for fulfilling open orders); and 2) the value of a new hold (e.g., the value of assets held for the margin transaction); if the portfolio has sufficient borrowing power, the requested margin transaction is executed.

In some variations, processing a transaction that triggers loan origination can include performing a market protection point check, which functions to protect the asset market for an asset related to the transaction. This can include: estimating (e.g., simulating) the effect the transaction would have on the market; completing the transaction when the order has a negligible effect on the market (e.g., change the asset price by less than a threshold amount); and managing fulfillment of the transaction (e.g., partially filling a trade order, splitting a trade order into a series of time-spaced sub-orders, etc.) if transaction fulfillment would substantially affect the market (e.g., if the transaction constitutes more than a threshold proportion of the order book; if the transaction would change the asset price by more than a threshold amount; etc.).

S216 functions to record data for the originated loan. In some implementations, the data recorded for the originated loan identifies at least one of: data included in the loan request, the borrow amount, the initial value of the loan, an identifier for each borrowed asset, an identifier for each collateral asset, an initial collateral amount for at least one collateral asset, an initial collateral requirement amount, an initial collateral requirement, price data used to determine the initial value of the loan, price data used to determine the initial collateral requirement, idempotency key (e.g., to prevent duplicate loan funding), price data used to determine each initial collateral amount for a collateral asset, and/or other data. However, any suitable information can be recorded for an originate loan. In some implementations, the loan is recorded for a portfolio associated with the loan. The loan can be not automatically funded at loan creation (e.g., wherein interim verification or transfer steps can occur between loan creation and loan funding), or be automatically funded at creation.

In a first example, if $100 is borrowed (a $100 margin loan) to execute a transaction to purchase BTC (bitcoin) on margin, then a margin loan of $100 is recorded for the transaction for the portfolio associated with the executed transaction. In a second example, if 250 BTC is borrowed then loan data that identifies the amount BTC borrowed (and optionally the value of the borrowed BTC in fiat currency) is recorded for the portfolio associated with the loan. In some implementations, the loan data is recorded in the database 170. However, the loan data can be recorded in any suitable database.

S220 functions to monitor an originated loan.

In some variations, monitoring an originated loan includes one or more of: calculating a collateral requirement amount for the loan S310, detecting assets that can be used as collateral for the loan S320; determining a value of assets that can be used as collateral S330; comparing the value of the assets that can be used as collateral to the collateral requirement S340, and determining a risk score S350 (as shown in FIG. 2B). In variants, S310, S320, S330, and S340 are similar to S410, S420, S430 and S440, respectively. However, an originated loan can be monitored in any suitable manner.

In variants, monitoring a loan S220 includes periodically performing one or more monitoring operations subsequent to origination of a loan (e.g., originated at S210). In some implementations, for each monitoring operation, a loan metric is calculated for the loan. The loan metric is calculated by accessing cryptocurrency price data for at least one cryptocurrency asset related to the loan (e.g., a borrowed cryptocurrency asset, a collateral cryptocurrency asset, etc.). In some implementations, the price data is accessed as described herein for S212, and optionally validated as described herein for S213.

In variants, calculating a loan metric includes calculating a current value for the loan (requested at S211). If the loan is for fiat currency (e.g., a fiat currency of a jurisdiction associated with the borrower), the value for the loan is the amount of fiat currency to be borrowed. If the loan is for cryptocurrency, the value for the loan in the fiat currency is calculated, based on a borrow amount of the cryptocurrency and validated cryptocurrency price data (in the fiat currency) accessed during the calculation of the loan value (e.g., accessed as described herein for S212 and S213). Collateral assets (including fiat currency and cryptocurrency assets) included in the monitored portfolio are detected (e.g., at S320 shown in FIG. 2B), and validated collateral cryptocurrency price data for the identified collateral cryptocurrency assets is accessed (as described herein for S212 and S213). A total value in fiat currency for the detected collateral cryptocurrency assets is calculated (e.g., at S330 shown in FIG. 2B) based on the validated collateral cryptocurrency price data. A total collateral asset value for the portfolio is calculated based on a total value of fiat currency included in the portfolio and the total value in fiat for the identified collateral cryptocurrency assets. In a first implementation, the total collateral asset value for the portfolio is a net collateral value that excludes the value of borrowed assets. In a second implementation, the total collateral asset value for the portfolio includes the value of borrowed assets, and the net collateral value is identified by calculating a difference between the total collateral asset value of the portfolio and the current value of all borrowed assets in the portfolio. The loan metric is a ratio of the net collateral value to the current value of the loan. In some implementations, detecting collateral assets included in the portfolio for the user (S320) comprises: identifying a set of collateral cryptocurrency assets that can be used as collateral for the loan, as described herein for S420. In some variations, the loan metric is compared to a collateral requirement amount at S340.

In some variations, monitoring a loan S220 includes determining, for each portfolio (e.g., a set of accounts associated with a single user), an equity percentage across all accounts. In some implementations, the equity percentage across all accounts for a portfolio is calculated total value of equity of the portfolio (e.g., measured in fiat currency, e.g., USD, or a base currency, e.g., BTC) divided by the total market value of the portfolio (e.g., as determined by pricing information provided by the market data ingester 111). In some implementations, the equity value of the portfolio is the difference between the market value of the portfolio and the total value of margin loans recorded for the portfolio.

In some variations, monitoring a loan S220 includes determining for each portfolio (e.g., a set of accounts associated with a single user) an equity percentage (Eₚ) for each cryptocurrency account. In some implementations, the equity percentage for a cryptocurrency account is calculated total value of equity of cryptocurrency held by the portfolio (e.g., measured in fiat currency, e.g., USD, or a base currency, e.g., BTC) divided by the total market value of the cryptocurrency held by the portfolio (e.g., as determined by pricing information provided by the market data ingester 111). In some implementations, the equity value of a cryptocurrency account is the total value of cryptocurrency assets acquired for the account by using portfolio equity (e.g., cryptocurrency assets required without using borrowed currency or assets).

In some variations, monitoring a loan S220 includes performing lending risk monitoring. Performing lending risk monitoring can include determining at least one risk score (e.g., at S350). Performing lending risk monitoring can include identifying one or more of lending risk monitoring for a user and performing lending risk monitoring across all users of the cryptocurrency platform 110. In variants, performing lending risk monitoring includes identifying (e.g., for a user, across all users) borrowed cryptocurrency assets and collateral cryptocurrency assets (e.g., by using recorded loan origination data recorded at S216 and account balances recorded in the account balances database 170), and identifying likelihood of forced liquidation based on price data for borrowed cryptocurrency assets and collateral cryptocurrency assets. Identifying likelihood of forced liquidation can include identifying price volatility in one or more cryptocurrency assets. For example, if a large percentage of collateral for loans originated by the cryptocurrency platform 110 is provided by volatile cryptocurrency assets, a sudden price drop for one or more of the collateral cryptocurrency assets can trigger forced liquidation (in potentially large amounts, and potentially across several users of the platform). Similarly, if a large percentage of loans originated by the cryptocurrency platform 110 are loans of volatile cryptocurrency assets (e.g., if volatile assets are being shorted), a sudden price increase for one or more of the borrowed cryptocurrency assets can trigger forced liquidation (in potentially large amounts, and potentially across several users of the platform) as the value of the loan exceeds collateral requirements.

In some implementations, performing lending risk monitoring includes identifying a liquidation risk of forced liquidations during a sudden price change for one or more cryptocurrencies (e.g., collateral cryptocurrencies, borrowed cryptocurrencies) across all loans managed by the cryptocurrency platform 110. In some implementations, liquidation risk identifies one or more of likelihood that liquidation orders can be matched with corresponding bids/asks, effect on market price of potential liquidation orders, or any other suitable metric.

In variants, the cryptocurrency platform performs one or more actions (e.g., at S250 in response to results of the lending risk monitoring (e.g., identified at S240). In some implementation, such actions include one or more of: suspending loan origination; restricting the types of cryptocurrencies that can be borrowed; restricting the types of cryptocurrencies that can be used as collateral; limiting loan amounts; staggering loan origination; suspending forced liquidation; staggering forced liquidations, or any other suitable action to manage lending risk.

In some implementations, results of lending risk monitoring are used to select cryptocurrency assets that can be used as collateral (e.g., at S420). For example, if the platform 110 has too much risk exposure to price volatility of a particular cryptocurrency asset, then this asset can be removed from the list of assets that can be used as collateral. Additionally, or alternatively, results of lending risk monitoring are used to select cryptocurrency assets that can be borrowed. For example, if the platform 110 has too much risk exposure to price volatility of a particular cryptocurrency asset, then the platform can exclude this asset from the list of assets that can be borrowed.

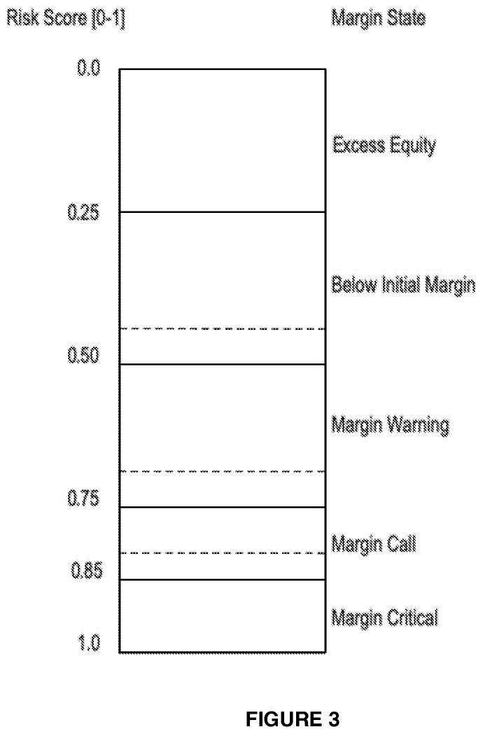

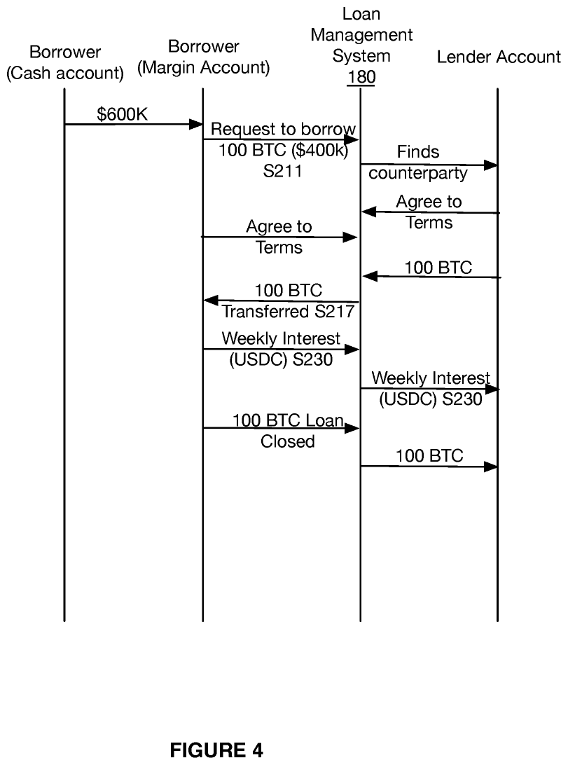

In some variations, monitoring a loan S220 includes using the equity percentage across all accounts to determine a risk score value for a current moment in time (e.g. at S350). In some implementations, the risk score value for a portfolio is the equity percentage across all accounts for the portfolio. In some implementations, the risk score values include one of a plurality of margin state values (e.g., “Excess Equity”, “Below Initial Margin”, “Margin Warning”, “Margin Call”, “Margin Critical”, etc.). In some implementations, the risk score values are numerical values that map to one of a plurality of margin state values (e.g., “Excess Equity”, “Below Initial Margin”, “Margin Warning”, “Margin Call”, “Margin Critical”, etc., as shown in FIG. 3), wherein the margin state values can each be associated with one or more threshold values.

In one variation, each margin state value can be associated with an entry threshold and an exit threshold, wherein a risk value dropping below the entry threshold classifies the portfolio with the margin state value (associated with the entry threshold), and a risk value exceeding the exit threshold classifies the portfolio with the margin state value (associated with the exit threshold). However, the entry and exit thresholds can function as event triggers (e.g., instead of portfolio labeling), or otherwise used. The entry threshold and the exit threshold can have the same or different numerical value, and can be static (e.g., globally; for a given portfolio, determined based on the portfolio's history, user's parameters; etc.), dynamically determined (e.g., based on the current market volatility, order book depth, etc.), or otherwise determined.

In some variations, a change in risk score value above a threshold results in a margin state change to higher risk margin state. In some variations, a change in risk score value below a threshold results in a margin state change to lower risk margin state. In some variations, a margin state has a first threshold for entering the margin state and a second threshold for exiting the margin state. In some implementations, the first threshold and the second threshold are different, thereby providing hysteresis to the system so that margin state is stable over small variations in the risk score value. In some examples, the distance between entry and exit thresholds for at least one margin state is on the order of 0.005. However, any suitable margin state distance can be used.

In some variations, the system defines margin states and their transactions as shown below in Table 1:

TABLE 1

| | | Possible | Possible |
|---|---|---|---|
| Margin State | Threshold | Entry Action | Exit Action |
| Excess Equity | Eₚ > Mᵢ | None | None |
| Below Initial | Eₚ < Mᵢ | Log | None |
| Margin | | | |
| Margin | Eₚ < M_{c} + | Send notification | None |
| Warning | (Warning buffer) | | |
| Margin Call | Eₚ < M_{c} | Send notification, | Cancel |
| | | Liquidate after | pending |
| | | remaining here until | liquidation |
| | | the required time | |
| | | (one day, eod?) | |
| Margin Critical | Eₚ < (Critical | Liquidate immediately | None |
| | Threshold) | | |

Eₚ—Overall equity percentage
Mᵢ—Initial margin percentage
M_{c}—Margin call threshold

As shown in Table 1, “Possible Entry Action” is an action for a transition to the margin state, and “Possible Exit Action” is an action for a transaction from the margin state to another margin state. However, in other variations, any suitable set of margin states, threshold values, and recommended actions (e.g., entry, exit) can be defined.

In some variations, margin state transitions are tracked over time (e.g., by the portfolio monitor 112).

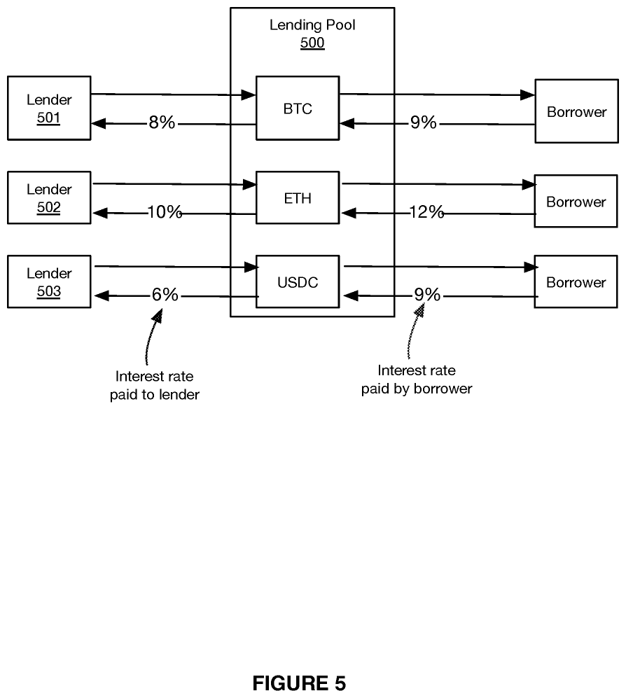

Calculating and transferring loan interest S230 can include identifying a principle amount of the loan (e.g., based on recorded loan information), identifying an interest rate for the loan, calculating interest on the principle of the loan by using the identified rate and principal amount, and transferring the loan interest to a lender account managed by the platform 110. In some variations, the principal amount for a loan of cryptocurrency is determined as a value of the borrowed cryptocurrency in fiat (e.g., USD value). Although the amount of the borrowed cryptocurrency may remain fixed during the duration of the loan, the fiat value of the borrowed cryptocurrency can change as the price (in fiat) of the cryptocurrency changes. Accordingly, the amount of each interest payment can vary as the price in fiat of the borrowed cryptocurrency changes. FIG. 4 depicts transfer of interest from the loan management system 180 to a lender account. The lender can be a user of the platform 110 (e.g., a user that lends to other borrowers), the platform 110, or a lending pool (e.g., 500 shown in FIG. 5) managed by the platform 110 (and funded by one or more individual lenders, e.g., 501-503 shown in FIG. 5). In an example, the interest rate used to calculate the interest is identified in the loan origination data recorded for the loan. In a first variation, calculating interest includes calculating compounding interest. In a second variation, interest is not compounded. The interest can be tracked: in the same ledger as the loan; as a separate charge to the borrower, tracked on a separate ledger; or otherwise tracked.

FIG. 6E shows exemplary interest calculation data for a loan of 250 BTC. As shown in FIG. 6E, the principal amount in BTC remains the same, but the value in USD of the borrowed BTC changes. Accordingly, the interest payment amounts change as the USD value of the BTC changes.

In variants, identifying a loan event S240 includes identifying a margin call event (e.g., as shown in FIG. 7).

In variants, identifying a loan event S240 includes identifying a liquidation risk event that identifies a risk of forced liquidation during a sudden price change for one or more cryptocurrencies across all loans managed by the platform 110.

Identifying a loan event S240 can include providing at least one loan event notification (e.g., a margin call notification). In some variations, the portfolio monitor 112 performs at least a portion of S240.

In some variations, identifying a loan event S240 includes generating an event notification for each margin state transition. In some variations, identifying a loan event S240 includes generating an event notification for each change in recommended action (e.g., “Possible Entry Action”, “Possible Exit Action”).

An event notification can be generated in response to: the equity percentage for the portfolio falling below a predetermined threshold; the margin state value for the portfolio satisfying a predetermined value; satisfaction of the event criteria (e.g., any of the previously discussed events) for a threshold period of time (e.g., predetermined value; dynamically determined value, based on portfolio or user parameters; etc.); and/or in response to occurrence of any other suitable event.

In some implementations, each event notification identifies at least one of: time of the event; user identifier for the event; margin profile identifier for the event; portfolio identifier for the event; numeric overall profile equity percentage; numeric equity percentage per cryptocurrency asset; numeric risk score value; previous margin state; current margin state; and/or recommended action. In some implementations, recommended action values include at least one of: “no action”, “notify”, “liquidate”, and “cancel liquidation”. However, in some implementations, event notifications can include any suitable type of information.

In some variations, if a margin state defines multiple recommended actions, an event can be generated for each recommended action.

In some variations, the profile monitor 112 periodically identifies margin states for each portfolio, and records the identified margin states in a database (e.g., with a respective time stamp).

Performing a loan action S250 can include processing a loan event (e.g., identified at S240). In some variations, the liquidation planner 113 performs at least a portion of S250. In variations, at least one of the liquidation persister 114, the portfolio monitor, and the trading system 120 performs at least a portion of S250.

Performing a loan action can include sending a liquidation instruction to a trading system (e.g., 120, an external trading system, etc.) to perform a liquidation.

Performing a loan action can include determining whether to send a liquidation instruction (or perform a liquidation) for a portfolio. In some variations, one or more of validated price data (e.g., accessed as described herein for S212 and S213), monitoring information (e.g., loan metrics, risk analysis results identified at S220), and loan event information identified at S240 are used to determine whether to perform a liquidation for a portfolio. In some implementations, the portfolio liquidation determination is made based on at least one of: a numeric overall profile equity percentage for the portfolio; a numeric equity percentage per cryptocurrency asset, for the portfolio; a numeric risk score value for the portfolio; a previous margin state for the portfolio; a current margin state for the portfolio; and/or recommended action for the portfolio.

In some implementations, in a case where an event notification generated at S240 indicates a liquidation action for a portfolio, a determination is made to trigger a liquidation for the portfolio at S250.

In some implementations, if information provided by at least one of the portfolio monitor 112 and the market data ingestor 111 indicates price dislocation or other risk factors for at least one asset of the portfolio, a determination is made not to trigger a liquidation for the portfolio at S250. For example, an event notification can be generated based on a change in asset price for at least one asset included in the portfolio. However, if there is price dislocation across exchanges that provide liquidity for the asset, then the determined price for the asset might not be accurate. In this case, it might be premature to perform a liquidation in response to a margin state change that occurs as a result of potentially inaccurate market data.

In some variations, at least one of the following factors are used to determine whether to trigger a liquidation for a portfolio: data indicating potential price dislocation for at least one portfolio asset; trading system order execution restrictions (e.g., of the trading system 120); order book depth for at least one portfolio asset; user information associated with the portfolio; margin rights for the portfolio; margin restrictions for the portfolio; liquidation caps; duration of existing margin loans (e.g., as limited by the Commodities Futures Trading Commission's 28 day rule).

In some variations, a liquidation is triggered before a duration of a loan exceeds 28 days.

In some variations, in a case where a liquidation is triggered for a loan to comply with the Commodities Futures Trading Commission's 28 day rule, the liquidated asset(s) is re-acquired by performing a margin transaction (thereby resulting in a new margin loan).

In some variations, a liquidation transaction is triggered responsive to a determination to perform a liquidation.

In some variations, at least one of the liquidation planner 113, the liquidation persister 114, the portfolio monitor 112, the trading system 120, and a trading system external to the platform 110 performs at least a portion of the liquidation process.

In some variations, performing a liquidation for a portfolio includes determining a set of one or more liquidation transactions to restore the portfolio's Equity Percentage back to the Initial Collateral Requirement. In some variations, determining a set of one or more liquidation transactions includes selecting portfolio assets to liquidate, and determining an amount to liquidate for each selected asset.

In some implementations, performing a liquidation includes generating liquidation plan information that identifies the determined liquidation transactions and providing the liquidation plan information to at least one of a liquidation transaction database (e.g., 115), the trading system 120, and the internal user interface system 117.

In some implementations, the liquidation plan information is provided to the trading system 120, which executes the liquidation transactions.

In some implementations, the liquidation plan information is provided to the database 115, the trading system 120 accesses the liquidation plan information from the database, and executes the liquidation transactions. The liquidation transaction can be executed by automatically generating a liquidation order (e.g., based on the liquidation plan information), optionally performing all or portions of S210, and submitting the liquidation order to the primary exchange (e.g., wherein any returns can be automatically credited back to any loans on the liquidated assets, returned to the user, etc.). However, the liquidation transaction can be otherwise executed.

In some implementations, the liquidation plan information is provided to the internal user interface system 117, the user interface system 117 receives user input confirming approval for the liquidation transactions, the user interface system 117 provides the liquidation plan information to the trading system 120 responsive to the user input, and the trading system 120 executes the liquidation transactions.

In some variations, each liquidation transaction is an off-chain transaction.

In some variations, at least one liquidation transaction is an off-chain transaction.

In some variations, performing a liquidation includes determining when to perform the liquidation transactions. In some implementations, the liquidation transactions are performed based on a determination that a market price for an asset to be liquidated is above a threshold value. In some implementations, execution of the liquidation transaction is postponed until the market price is above the threshold value.

In variants, performing a loan action S250 includes suspending loan origination by the platform 110.

In variants, performing a loan action S250 includes recording auditing information for the loan action. In some implementations, the auditing information identifies information related to at least one loan action performed at S250. Such actions can include a margin call for a loan, a forced liquidation for a loan, or any other suitable action.

In some implementations, the auditing information related to a margin call identifies at least one of: margin call price data used to trigger the margin call, price validation information for the margin call price data, a source identifier for the margin call price data, and a digital signature for the margin call price data.

In some implementations, the auditing information related to a forced liquidation identifies at least one of: forced liquidation price data used to trigger the forced liquidation, price validation information for the forced liquidation price data, a source identifier for the forced liquidation price data, and a digital signature for the forced liquidation price data.

In variants, performing a loan action S250 includes providing auditing information for the loan to at least one computing system external to the platform 110.

The method can optionally include receiving a payment from the borrower. The payment from the borrower can be applied: to the newest loan principal, the oldest loan principal, the newest interest charge, the oldest outstanding interest charge, according to a set of rules (e.g., to the oldest interest charge, then to the oldest principal; to the interest before the principal; etc.), or otherwise applied. In a specific example, the system can pause interest calculations in response to receipt of borrower payment indication (e.g., ACH information receipt) of an amount greater than a threshold amount (e.g., the interest amount, percentage of the loan amount, predetermined amount, etc.), and resume interest accrual after the payment is received. However, the system can otherwise manage borrower payments.

FIGS. 6A-D show exemplary data recorded for loans.

FIG. 6A shows exemplary data for a loan of 250 BTC. As shown in FIG. 6A, a margin call is initiated on day 10, and a successful margin call deposit is deposited on day 10.

FIG. 6B shows exemplary data for a loan of 1,000,000 USDC. As shown in FIG. 6B, a margin call is initiated on day 11, and a successful margin call deposit is deposited on day 11.

FIG. 6C shows exemplary data for a loan of 250 BTC. As shown in FIG. 6C, a margin call is initiated on day 10, and forced liquidation is performed on day 11.

FIG. 6D shows exemplary data for a loan of 1,000,000 USDC. As shown in FIG. 6D, a margin call is initiated on day 11, and forced liquidation is performed on day 11.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method comprising: with a cryptocurrency platform:
originating a loan of cryptocurrency for a user;
monitoring the loan, comprising: for each monitoring operation performed subsequent to origination of the loan, calculating a loan metric for the loan by:
accessing cryptocurrency price data for the cryptocurrency from a cryptocurrency trading system, and
validating the accessed cryptocurrency price data;
identifying a loan event based on the monitoring of the loan; and
performing a loan action based on the identified loan event.

2. The method of claim 1, wherein at least one of a loan management system included in the platform and the cryptocurrency trading system originates the loan.

3. The method of claim 2, wherein originating the loan comprises:
identifying a loan request for the loan of cryptocurrency, wherein the loan request identifies the cryptocurrency and a borrow amount of the cryptocurrency;
accessing initial cryptocurrency price data in fiat currency for the cryptocurrency from the cryptocurrency trading system;
validating the accessed initial cryptocurrency price data;
calculating an initial value of the loan in fiat currency based on the borrow amount and the validated initial cryptocurrency price data;
calculating an initial collateral requirement amount in fiat currency for the loan based on the initial value of the loan and an initial collateral requirement for the loan;
detecting collateral having a value at least equal to the initial collateral requirement amount in a loan account of the user;
in response to detecting the initial collateral requirement amount:
recording loan origination data for the loan, and
transferring the borrowed amount of the cryptocurrency to the loan account,
wherein the loan origination data identifies at least one of: the borrow amount, the initial value of the loan, an identifier of for the cryptocurrency, the initial collateral amount, and a type of the collateral.

4. The method of claim 3, wherein detecting collateral having a value equal to the initial collateral amount in a loan account of the user comprises detecting one or more of fiat currency and collateral cryptocurrency assets that can be used as collateral.

5. The method of claim 4, further comprising, with the cryptocurrency platform:
performing lending risk monitoring by using data recorded for loans managed by the cryptocurrency platform and corresponding validated cryptocurrency price data accessed from the cryptocurrency trading system; and
updating a set of collateral cryptocurrency assets that can be used as collateral for the loan, based on results of lending risk monitoring.

6. The method of claim 4,
wherein calculating the loan metric during a monitoring operation comprises:
calculating a current value of the loan in fiat currency based on the borrow amount of the borrowed cryptocurrency and the validated cryptocurrency price data accessed during the monitoring operation,
identifying collateral cryptocurrency assets included in the loan account for the user,
accessing validated collateral cryptocurrency price data for the identified collateral cryptocurrency assets;
calculating a total value in fiat for the identified collateral cryptocurrency assets based on the validated collateral cryptocurrency price data,
calculating a total collateral asset value for the loan account based on a total value of fiat currency included in the loan account and the total value in fiat for the identified collateral cryptocurrency assets, and
identifying a net collateral value by calculating a difference between the total collateral asset value for the loan account and the current value of the loan,
wherein the loan metric is a ratio of the net collateral value to the current value of the loan,
wherein identifying collateral assets included in the loan account for the user comprises: identifying a set of collateral cryptocurrency assets that can be used as collateral for the loan, based on results of lending risk monitoring.

7. The method of claim 4,
wherein the loan event is a platform liquidation risk event that identifies a risk of forced liquidations during a sudden price change for one or more cryptocurrencies across all loans managed by the cryptocurrency platform, and
wherein performing a loan action comprises suspending loan origination by the cryptocurrency platform.

8. The method of claim 3, wherein the borrowed amount of the cryptocurrency is transferred from a cryptocurrency account managed by the cryptocurrency platform.

9. The method of claim 8, further comprising, with the cryptocurrency platform, accessing user input identifying selection of the cryptocurrency trading system from a set of selectable cryptocurrency trading systems.

10. The method of claim 8, further comprising, with the cryptocurrency platform, providing auditing information for the loan to at least one computing system external to the cryptocurrency platform, the auditing information identifying information related to at least one of a margin call for the loan and a forced liquidation for the loan.

11. The method of claim 10,
wherein auditing information related to a margin call identifies at least one of: margin call price data used to trigger the margin call, price validation information for the margin call price data, a source identifier for the margin call price data, and a digital signature for the margin call price data, and
wherein auditing information related to a forced liquidation identifies at least one of: forced liquidation price data used to trigger the forced liquidation, price validation information for the forced liquidation price data, a source identifier for the forced liquidation price data, and a digital signature for the forced liquidation price data
wherein the cryptocurrency trading system initiates origination of the loan.

12. The method of claim 6, wherein performing a loan action comprises providing a margin call notification to at least one system.

13. The method of claim 6, wherein performing a loan action comprises providing a forced liquidation notification to at least one system.

14. The method of claim 6, wherein performing a loan action comprises performing a forced liquidation using the cryptocurrency trading system.

15. The method of claim 1, further comprising, with the cryptocurrency platform:
periodically calculating interest in fiat currency for the loan of cryptocurrency and transferring the calculated interest to a lender account.

16. The method of claim 15, wherein periodically calculating interest in fiat currency for the loan of cryptocurrency comprises: for each interest calculation:
accessing cryptocurrency price data in fiat currency for the cryptocurrency from the cryptocurrency trading system;
validating the accessed cryptocurrency price data;
calculating a current value of the loan in fiat currency based on the borrow amount and the validated cryptocurrency price data;
identifying an interest rate for the loan; and
calculating interest on the calculated current value of the loan by using the identified rate.

17. A method comprising: with a cryptocurrency platform:
originating a loan for a user, wherein at least one cryptocurrency asset is used as collateral for the loan;
monitoring the loan, comprising: for each monitoring operation performed subsequent to origination of the loan, calculating a loan metric for the loan by: for each cryptocurrency asset used as collateral for the loan:
accessing cryptocurrency price data for the cryptocurrency asset from a cryptocurrency trading system, and
validating the accessed cryptocurrency price data;
identifying a loan event based on the monitoring of the loan; and
performing a loan action based on the identified loan event.

18. The method of claim 17, wherein originating the loan comprises:
identifying a loan request for the loan;
determining an initial value of the loan in fiat currency;
calculating an initial collateral requirement amount in fiat currency for the loan based on the initial value of the loan and an initial collateral requirement for the loan;
detecting cryptocurrency assets of the user that can be used as collateral for the loan;
for each detected cryptocurrency asset, determining a value of the detected cryptocurrency asset by accessing initial cryptocurrency price data in fiat currency for the cryptocurrency asset from the cryptocurrency trading system, validating the accessed cryptocurrency price data, and calculating the value of the detected cryptocurrency asset based on the validated cryptocurrency price data;
determining a total collateral value of the detected cryptocurrency assets by summing the determined value for each detected cryptocurrency asset;
comparing the total collateral value to the initial collateral requirement amount in response to detecting that the total collateral value satisfies the initial collateral requirement amount:
recording loan origination data for the loan, and
transferring the borrowed amount to the loan account.

19. The method of claim 18, wherein detecting cryptocurrency assets of the user that can be used as collateral for the loan comprises detecting the cryptocurrency assets based on lending risk monitoring.

20. The method of claim 19,
wherein calculating the loan metric during a monitoring operation comprises:
determining a collateral requirement amount,
detecting cryptocurrency assets of the user that can be used as collateral for the loan;
for each detected cryptocurrency asset, determining a value of the detected cryptocurrency asset by based on the validated cryptocurrency price data;
determining a total collateral value of the detected cryptocurrency assets by summing the determined value for each detected cryptocurrency asset;
comparing the total collateral value to the determined collateral requirement amount; and
determining a risk score based on the comparison of the total collateral value to the determined collateral requirement amount.
